(19) United States
(12) Patent Application Publication
(10) Pub. No.: US 2007/0141341 A1
(43) Pub. Date: Jun. 21, 2007

(54) Coating containing denatured aloe vera, for covering either chlorine-generating compositions or other hazardous chemicals and method for making

(76) Inventor: Aaron DeWald, St. Ann, MO (US)

Correspondence Address: HAVERSTOCK, GARRETT & ROBERTS LLP, 611 OLIVE STREET, SUITE 1610, ST. LOUIS, MO, 63101, US

(21) Appl. No.: 11/300,857

(22) Filed: Dec. 15, 2005

(51) Int. Cl. B32B 9/02; B09B 3/00; B09B 1/00

(52) U.S. Cl. 428/402.24; 588/261; 588/249

(57) ABSTRACT

Hazardous chemicals, particularly chlorine-generating compositions, are coated with a colloidal suspension of denatured aloe vera and a lipid wherein the coating has improved inertness against chlorine reactivity and resistance to chlorine diffusion from within and resistance to atmospheric moisture from outside.

### BACKGROUND OF THE INVENTION

1. Field of the Invention

This invention relates to coated particles, coatings, and methods for making coatings for hazardous chemicals, particularly coatings for covering chlorine-generating compositions, and more particularly, the invention relates to coatings having improved chemical inertness against highly oxidative chlorine reactivity.

2. Description of the Prior Art

A wide variety of chlorine-generating solid compositions, capable of releasing chlorine at ambient temperatures when contacted with fluid media, have been particularly useful for sanitizing bacteria and other micro-organisms in swimming pools. These chlorine-generating compositions have included, for example, chlorinated cyanuric acid compounds, metal hypochlorites (especially alkaline earth metal hypochlorites), chlorihated-triazines, chlorinated isocyanuric acids, chlorinated melamines, chlorinated hydantoins, chlorinated glycolurils, etc., and combinations thereof.

Although these chemical compositions are quite effective in sanitizing fluid media, they do have disadvantages. First of all, it is often difficult to control their rate of dissolution into the fluid media. Additionally, they emit chlorinous vapors into the atmosphere which are offensive, if not hazardous, to people in the vicinity of the treatment area, and can be explosive. Shipping and handling of the various tablets or powders can result in chipping away of small fragments and grinding of the fragments into a dust which remains in shipping cartons and vehicles. If the dust or powder is poured into fluid media, there can result a rapid release of chlorine, as opposed to a gradual erosion of the chemical, and the rapid release of chlorine is extremely hazardous. Furthermore, the chlorine-containing compositions, upon exposure to the atmosphere, may absorb moisture and carbon dioxide, causing caking or agglomeration of the composition and further release of chlorine from the composition, thus reducing the compositions, effectiveness when ultimately used in treating the fluid media.

In order to overcome these drawbacks, as disclosed by Horvath et al. in U.S. Pat. No. 3,647,523, coatings have been proposed for these chlorine-generating compositions. Two particularly useful alternative coatings, i.e.

(1) polyvinylpyrrolidone (PVP), and (2) chlorinated paraffins (having from 40 to 70% chlorine and sold as CHLOROWAX) were proposed. Such coatings were contemplated to stabilize the solid compositions during handling and shipping and help control dissolution into fluid media.

Neither PVP nor the paraffin coatings, however, have proven to be chemically inert to the chlorine-generating compositions. For example, most of the chlorine-generating compositions are strong oxidizers, particularly the chlorinated cyanuric acids, and the hypochlorites. Today it is known that such chlorine-generating oxidizers are incompatible with “strong reducing agents”, and PVP is a strong reducing agent. Currently, PVP is considered such a strong reducing agent that its material safety data sheets routinely warn that it is incompatible with strong “oxidizing agents”, such as the chlorine-generating composition used in treating fluid media, thus negating its use as a coating for such chlorine-generating compositions. CHLOROWAX has also been found to react with strong oxidizers. Conversely, the material data sheets for the chlorine generating compounds, routinely warn of their incompatibility with reducing agents or any other readily oxidizable materials.

Horvath et al., ibid., did teach to dissolve either the CHLOROWAX or the PVP in methylene chloride prior to using them as coatings. However, such a precaution is not itself without drawbacks. That is, for example, methylene chloride is listed among suspected human carcinogens. Although the methylene chloride is non-flammable and non-explosive in air, it does carry an ether-like odor and is a relatively volatile liquid. It is only slightly soluble in water, which slightness can aid in controlling dissolution of the chlorine-generating solids. However, methylene chloride is also very viscous and difficult to handle. Accordingly, when the chlorine-generating compositions are dipped in the methylene chloride solvent or when the solvent is sprayed onto the compositions, followed by an extraneous drying step, the cumulative effect of the extra precautions needed for use of methylene chloride lead to added time, and expense, and may have a more negative effect than positive.

PVP and CHLOROWAX coatings do not foster accumulation of bacteria and mold during storage since there is diffusion or release of residual chlorine through the coating. However, that advantage is outweighed by the other disadvantages associated with the coatings' chlorine reactivity.

As a consequence of the foregoing inadequate procedures and material drawbacks in the prior art coatings, workers in manufacturing and handling many hazardous solids such as the chlorine-generating compositions, instead routinely work with uncoated solid products. Accordingly, they are required to take extraordinary measures for protecting themselves against chlorine burns and against exposure to breathing chlorine gas. For example, a standard chlorine meter, used to measure exposure to chlorine levels, has a scale of 0 to 10. A chlorine level of merely 1 requires that workers, exposed thereto, for any appreciable period of time, must use a respirator, which takes in ambient air while filtering the gas and dust from the air. A chlorine level approaching 10 means there is no oxygen left in the air to breath such as during fires and/or when the compositions become wet. Therefore, a chlorine level approaching 10 requires, inter alia, use of a self-contained breathing apparatus, which apparatus has its own independent oxygen tank.

Additionally, workers exposed to high levels of chlorine or even lower levels below 1 are required to apply topical lotions for protection of the skin. An important component of such lotions is aloe vera gel. Until now, aloe vera has been important because of the healing power derived from active glycoprotein fractions which behave similarly to proteinaceous chains of amino acids joined by polypeptide bonds. That is, interactive forces within the primary chain structures cause the glycoprotein chains to fold back on themselves, creating secondary structures. Interactive forces within the side chains of these secondary structures are believed to provide overall stability to the glycoprotein chains. The configurations given to the structures, as a consequence of the side chains, are referred to as their tertiary structures. Accordingly, while side chains on the inside of the tertiary structures give the glycoproteins their physical strength, side chains on the outside of the tertiary structure interact with external constituents such as water molecules to enable, e.g. solubility of the glycoproteins.

The active glycoproteins of the aloe vera gel are known to promote several different healing characteristics. Included among those healing properties are for example (1) enabling aloe vera gel to serve as a moisturizing agent, (2) enabling aloe vera to have aspirin-like effect in the presence of salicylates, and (3) enabling aloe vera gel having magnesium lactate, to function as an antihistamine. Accordingly, the active aloe vera gel has the ability to inhibit pain and, according to some scholars, to act on the immune system to provide immunomodulatory properties. Also, often mentioned are the antibacterial, antifungal and even antiviral properties demonstrated by the biologically active gel. It has even been postulated that aloe vera in its active form, in addition to being a healing agent when fed orally to patients, can also heal when injected into the blood stream. However, the lotions containing aloe vera of the prior art are still not strong enough to alone protect workers from chlorine burns. Gloves, masks, and protective suits are needed.

That is, chemical reactions and/or physical forces capable of disrupting the secondary and tertiary structures of the aloe vera glycoproteins will cause unfolding or denaturing of the proteinaceous cellular structure from its folded or native, active state. The denatured or unfolded structures are biologically inactive and generally coagulate or otherwise become insoluble. The denatured aloe vera resembles egg whites, which, when cooked, turn into insoluble white solids, because their principal proteins, ovalbumen, are denatured by heat at about 65° C.

As observed by B. C. Coates in U.S. Pat. No. 5,356,811, entitled Method of Processing Stabilized Aloe Vera Gel obtained from the Whole Aloe Vera Leaf,
“the application of heat to aloe vera gel produces adverse side effects. Among those side effects are the fact that the heat destroys a substantial portion of the biologically active ingredients within the gel and, thus, inhibits its efficacy as a medicinal compound. For example, heating of the gel contributes to the destruction of mucopolysaccharide as well as other enzymes and proteins which are believed to be responsible for a substantial portion of the therapeutic effects of aloe vera gel.”
   Accordingly, it is not unexpected that chlorine exposure, severe enough to burn the skin can, in fact, even attack the aloe vera lotion.

Rex G. Maughan did postulate in U.S. Pat. No. 6,869,624, issued Mar. 22, 2005, that it was possible to stabilize aloe vera gel activity for transportation and storage by heating it in the range of 35° C. to about 80° C. in the presence of stabilizing preservatives and antioxidants such as tocotrienol/tocopherol blend, rosmarinic acid, polyphenols, or combinations thereof. The aloe vera when so treated with antioxidants allegedly maintains its therapeutic qualities over a significantly increased shelf life because the final aloe vera was not denatured. However, even so, such stabilized aloe vera still cannot withstand the attack of highly oxidative chlorine-generating compositions.

It would therefore be an unexpected advancement in the art, and would solve a long-felt need, if there were a safer and more expedient coating for chlorine-generating compositions, used in treating fluid media, which coating could substantially inhibit the release of chlorine gas until dissolution in the media, and exert inertness toward chlorine reactivity, while also serving as a diffusion barrier, and also would substantially inhibit the chlorine-generating compositions from fragmentation and crumbling, thus allowing workers to minimize the need for protective clothing, gloves, mask, and substantially reduce the occurrences where protective equipment such as respirators and self-contained breathing apparatus are needed.

### SUMMARY OF THE INVENTION

I have surprisingly and unexpectedly discovered an aloe vera coating, for hazardous solids, which is protectively inert to chlorine attack, when the aloe vera is biologically inactive.

The previous drawbacks of the prior art practice of coating hazardous solids, particularly chlorine-generating compositions for use in treating fluid media, are overcome through the practice of the present invention, which coats compositions with a heat denatured colloidal suspension of aloe vera gel, having a lipid support vehicle, which is encapsulated therein and/or impregnated therethrough.

It is a feature of the present invention that the chlorine-generating compositions do not oxidize the denatured aloe vera lipid coatings, and therefore, to that extent, inter alia, have improved inertness.

It is a further feature of the present invention that the coatings do not require the odorous, viscous, and difficult to handle carcinogenic solvents of the prior art.

It is an additional feature of the present invention that the denatured aloe vera lipid coatings can be stored at room temperature and remain stable for very long periods of time, even without the presence of antioxidants. In fact, neither mold nor bacteria collect at the surface of the materials despite their being no appreciable diffusion of chlorine through the inert coatings.

It is an important feature of the invention that the coating has improved resistance to chlorine or other gaseous diffusion from inside and improved resistance to diffusion of atmosphere moisture from outside, thereby inhibiting caking and agglomeration in addition to inhibiting chlorine odor.

It is also a feature of the present invention that the denatured aloe vera lipid, in coating the chlorine-generating materials, does dry rapidly at ambient temperatures and pressures, and negates the need for the cumbersome procedures of the prior art. The coatings, when applied to the compositions under ambient conditions, do not require extraneous drying steps.

The final, coated chlorine-generating compositions of the present invention are free flowing, non-agglomerated tablets, granules or powders, having improved resistance to crumbling and fragmentation. The coating process proceeds under ambient conditions, without the risk associated with using carcinogens and without risking reaction between either the coating, the chlorine-generating composition, or the subsequently released chlorine gas.

The coatings also dissolve in fluid media at effective rates for purposes of sanitizing fluid media.

### DETAILED DESCRIPTION OF THE PREFERRED EMBODIMENTS

In the process of the present invention, aloe vera glyco protein is denatured by a combined chemical and physical effect, i.e., (1) acidification of aloe vera gel with any effective mild protein-precipitating acidic component, preferably acetic acid, and (2) heating against a lipid support.

The lipid supports are preferably glyceryl esters of higher saturated fatty acids, particularly esters of stearic and palmitic acids, e.g. fats. The lipids are called “supports” because when admixed with aloe vera and processed property, the lipid provides texture, firmness, adhesion and most of the film forming characteristics for the coating Those esters and their mixtures are substantially and preferably solid at room temperature, and exhibit crystalline structure. Lard and tallow are examples of suitable lipid supports, but it is particularly preferred to use cholesterol esters of higher fatty acids and triglycerides, including for example hydrogenated, ethoxylated, or acetylated derivatives, e.g. lanolin.

The aloe vera gel of the present invention may be derived from any of a number of sources. Aloe vera is a subtropical plant which has elongated leaves containing a viscous gel. The gel can be derived from either of at least two sources on the plant. There is a mucilaginous yellow fluid which comes from the base of the leaves of the plant adjacent the leaf rind. The yellow fluid is better known as aloin and has in the past been used as an active ingredient in cathartics and medicinal purges. Alternatively, there is a clear gel taken from within the body of the elongated leaves and is known for therapeutic healing on bumps, insect bites, and other injuries. The presence of gel polysaccharides, especially the acetylated mannans, is desirable. The active glycoprotein fractions from either pure aloe vera or aloe arborescence are principle components of the gel fractions employed in the present invention. The gel may be derived from any of the approximately 325 species of aloe which are known. Most are indigenous to Africa. For example, aloe barbadensis is a native North African species, but comes from Barbados where it has grown wild since its introduction in 1630. Also, there is a variety of that species called Aloe Chinensis Baker, which can be obtained from Curacao where it was introduced by William Anderson in 1817 from China. Others include, for example, Aloe Perryi Baker, Aloe Ferox Miller, Aloe Africana Miller, Aloe Spicata Baker, etc.

In the process of the present invention, colloidal suspensions preferably having the lipid encapsulated within or impregnated throughout the denatured aloe vera gel may be prepared using any conventional equipment or techniques for making emulsions and suspensions. Also, it may be possible for the aloe vera to at least partially if not substantially impregnate the lipid and still provide a satisfactory product once coated over solid hazardous materials, but it is preferred that the aloe vera dominate and encapsulate the lipid support. The coatings may be applied to the hazardous solid materials using any of the known methods for applying liquid coatings to solid materials.

One method, for preparing coatings of the present invention, involve denaturing pre-mixed hand lotion containing aloe vera and lanolin.

The denaturization begins by adding to the lotion a mild reactive aqueous acidic solution, preferably an acetic acid solution, at sufficient concentrations, to unfold the aloe vera glycoprotein structure. Certain preservative acids which would not unfold the protein, such as rosemarinic acid and others used in the process of U.S. Pat. No. 6,869,624 should not be used alone. Sufficient acidity is achieved at pH 3-6 for acids such as acetic and others which are water-soluble mild, reactive and non-hydrolyzing in the presence of proteins. Higher acidity, i.e. lower pH, and/or more harsh acids may be employed when it is desired to hasten the denaturization, but commensurate care must be exercised in accordance with conventional techniques needed to avoid substantially hydrolyzing the protein. More specifically, the acid can be added in an amount of from about 30% to about 60% by volume based upon the volume of the aloe, when the acid is a substantially water-soluble reactive but non-hydrolyzing acid toward proteins, for example, acetic, formic, carbonic, or other similarly water-soluble mild organic acid or mixtures thereof to provide a concentration of as much as 4-5% by weight. Thereafter, the mixture is heated at about 35° C. to about 80° C., until a milky coagulate precipitates at the top of the solution. Higher temperatures hasten the process, but at higher temperatures, a commensurate degree of care is needed to allow unfolding of the glycoprotein, but avoid burning, hydrolyzing, or otherwise destroying or undesirably degrading the aloe vera. The amount of acid, preferably acetic acid, employed on a weight-to-weight basis is 15-35 parts of 5% aqueous solution of such acid per 10-25 parts of lipid, preferably lanolin, and per 30-40 parts of aloe vera gel. The acid solution to be used can have from about 3% to about 15% acetic acid by weight, even through it has preferably 5-10%. Finally, the mixture is cooled and the precipitate is separated. Once separated, the precipitate is itself melted and applied as a liquid coating to any of the chlorine-generating solid compositions or to other similar hazardous solids.

Chemicals other than acid may be equivalent to and/or used to denature the aloe, such as sodium dodecyl sulfate; however, it is critical that conditions are employed for allowing the proteins to only be unfolded and not to be hydrolyzed. To the extent that materials or conditions do hydrolyze the protein, such materials or conditions or techniques should be avoided, and are outside the contemplated scope of this process.

However, it is especially preferred that during denaturization, the aloe vera and lipid be provided separately, rather than being premixed in a lotion, as previously described. The two ingredients can be admixed without surfactants or antioxidants or other adjunct components routinely found in hand lotion. Glacial acetic acid or its equivalent as, for example, is found in the form of normal white vinegar may be admixed to the aloe and the lipid support, but at the ratios and quantities of acid previously discussed.

The methods of this invention may be particularly useful for coating solid derivatives of cyanide or other hazardous compounds.

It will become readily apparent to those skilled in the art that additional, equivalent or alternative embodiments may be employed, and are within the contemplation of this invention; accordingly, the following examples are provided for illustrative specificity, but are not intended to unduly limit the scope of the invention as claimed herein.

### EXAMPLE 1

A batch of coating material is prepared by weight-to-weight admixing of 25 parts lanolin, 40 parts aloe vera, and 15 parts of a 5% acetic acid aqueous solution. The mixture is stirred vigorously to initially form and then evenly disperse a milky coagulate. Next the mixture is brought to a boiling point for from 10 to 15 minutes, preferably 5 minutes. Then the mixture is cooled for 30 minutes at room temperature, or lesser time may be employed if the material is refrigerated during the cooling step. There results a two phase product which evolves after the mixture is allowed to sit and cool. The bottom phase is a clear or transparent liquid while the top phase is an opaque hardened coagulate.

The clear or transparent liquid is drained and separated from the coagulate. The coagulate is then heated until melted and is thereafter added to granules of a solid chlorine-generating material known as Granular ACL 90 which an occidential chemical company brand of trichloroisocyanuric acid. The weight-to-weight ratio is 10 parts (2 gms) coagulate to 1000 parts ACL 90 chlorine-generating solid material. The amount of ACL 90 treated was 200 gms and labeled X.

### COMPARATIVE EXAMPLE 2

Polyvinylpyrrolidone (PVP)

A granular 90% ACL chlorine-containing composition in an amount of 200 gms, i.e., identical to the amount in Example 1 was coated with 5% by weight of the ACL polyvinylpyrridone and labeled as A, in the manner of U.S. Pat. No. 3,647,523.

Paraffins

An identical amount of Granular ACL 90% chlorine-containing composition as provided in Example 1 and as above in the PVP example was coated with 4% by weight of the ACL of resinous paraffin (CHLOROWAX) and labeled as B, in the manner of U.S. Pat. No. 3,647,523.

The results of testing X, A, B are set forth in Table I below:

TABLE I

| | | | Chlorine | |
|---|---|---|---|---|
| | | | Meter | |
| | Odor | Texture | Reading | Solubility |
| X | very slight | flowable | <.5 | 100% |
| A | significant | sticky, | 1.7 | 100% |
| | | viscous | | |
| B | significant | sticky, | 1.8 | 100% |
| | | clumpy | | |

TABLE II
This table gives the following reductions
of E. coli organisms after one-half hour.

| | | CHLORO- | | |
|---|---|---|---|---|
| | PVP | WAX | Aloe Vera | |
| | Coated | Coated | Coated | Uncoated |
| | ACL (A) | ACL (B) | ACL (X) | ACL |
| E. coli | comparable | comparable | comparable | Slightly |
| remaining | | | | lower |
| after: | | | | concentration |
| ½ hour | | | | than when |
| | | | | coated |
| after 5 | 0 | 0 | 0 | 0 |
| minutes | | | | |

The dissolution rate for coated chlorine-containing compounds is slightly slower than for uncoated chlorinated compounds. Slightly more E. coli is present after ½ hour with coated materials than uncoated.

1. An improved chlorine-generating solid composition, of the type used to treat fluid media and comprising a member selected from the group consisting of alkali metal hypochlorites, alkaline earth metal hypochlorites, chlorinated triazines, chlorinated cyanuric acids, chlorinated isocyanuric acids, chlorinated melamines, chlorinated hydantoins, chlorinated glycolurils, and mixtures thereof:
the improvement comprising:
said solid composition being enveloped by a colloidal suspension of aloe vera gel on a solid lipid support, said gel being denatured both by a water-soluble mild reactive, but non-hydrolyzing acidic component and by heat,
whereby the coated composition has improved inertness, improved stability, and improved handling and improved storage characteristics.

2. The improved composition of claim 1 wherein the lipid support is a member selected from the group consisting of animal fat, lard, tallow, and lanolin.

3. The composition of claim 2 wherein the lipid is lanolin.

4. The composition of claim 1 wherein the solid chlorine-generating composition is either granular or in tablet form.

5. The composition of claim 1 wherein the chlorine generating solid is trichloro isocyanuric acid.

6. The composition of claim 1 wherein the chlorine-generating solid composition is either calcium hypochlorite or sodium hypochlorite.

7. The composition of claim 1 wherein the chlorine-generating solid is selected from the group consisting of dichloroglycoluril and tetra chloroglycoluril.

8. The composition of claim 1 wherein the weight-to-weight ratio of acid:lipid:aloe vera is 15-35:10-25:30-40.

9. A solid hazardous material having a thin coating comprising a glyceryl ester of a higher fatty acid suspended colloidally in acid and heat denatured aloe vera.

10. The solid material of claim 9 wherein the glyceryl ester is lanolin.

11. The material of claim 9 wherein the ratio of denaturizing acid:glyceryl ester of higher fatty acid:denatured aloe vera is 15-35:10-25:30-40.

12. A method for improving the stability and handling of hazardous solid materials comprising admixing said hazardous material with a colloidal suspension of chemically heat-denatured aloe vera on a lipid support, said lipid support comprising a glyceryl ester of higher fatty acid, and allowing said mixture to dry under ambient conditions;
whereby said colloidal suspension encapsulates the solids during admixture.

13. The method of claim 12 wherein the glyceryl ester of a higher fatty acid is lanolin.

14. A method for making chemically and physically denatured aloe vera coating for hazardous solids comprising
a) mixing water, aloe vera gel, a mild water-soluble protein precipitating acidic component, and a lipid selected from either lanolin, tallow, or animal fat, and
b) boiling the mixture;
c) cooling the mixture to room temperature; and
d) draining the remaining liquid,
whereby the lipid colloidally encapsulated within the aloe and readily dries under ambient conditions.

15. The method of claim 14 wherein the mild acidic component is acetic acid.

16. A coating for hazardous solid chemicals comprising a glyceryl ester of higher fatty acids colloidally suspended in denatured aloe vera gel.

17. The coating of claim 16 wherein the glyceryl ester of higher fatty acid is selected from the group consisting of fat, lard, tallow and lanolin.

18. The coating of claim 16 or 17 wherein the aloe vera gel is denatured by heating from 35° C. to 80° C. in the presence of a mild water-soluble protein-precipitating acidic component and in admixture with the glyceryl ester of a higher fatty acid.

19. The coating of claim 18 wherein the water-soluble mild protein-precipitating acidic component is acetic acid.

20. The composition of claim 1 wherein the water-soluble mild reactive, nonhydrolyzing acidic component is selected from the group consisting of formic, acetic, carbonic, and other mild organic acids and mixtures thereof.

21. The composition of claim 1 wherein the water-soluble mild reactive, nonhydrolyzing acidic component is acetic acid.

22. The composition of claim 1 wherein the water-soluble mild reactive, nonhydrolyzing acidic component is sodium dodecyl sulfate.

23. The composition of claim 1 wherein the gel is a glycolprotein equivalent of aloe vera.
